(19) United States
(12) Patent Application Publication
(10) Pub. No.: US 2020/0218378 A1
(43) Pub. Date: Jul. 9, 2020

(54) OPERATION DETECTION DEVICE

(71) Applicant: KABUSHIKI KAISHA TOKAI RIKA DENKI SEISAKUSHO, Aichi (JP)

(72) Inventor: Toshihito TAKAI, Aichi (JP)

(21) Appl. No.: 16/627,553

(22) PCT Filed: Jul. 20, 2018
(86) PCT No.: PCT/JP2018/027350

§ 371 Date: Dec. 30, 2019

(30) Foreign Application Priority Data
Aug. 8, 2017 (JP) 2017-153180

(51) Int. Cl. G06F 3/044

(52) U.S. Cl. CPC G06F 3/044

(57) ABSTRACT

An operation detection device includes an operation unit including an operation surface to be operated thereon, a base portion to which the operation unit is attached, a plurality of load sensors that are arranged between the operation unit and the base portion to detect a load applied to the operation surface, and a plurality of elastic bodies that are attached to the base portion and to the operation unit to cause the plurality of load sensors to contact with the operation unit by an elastic force thereof.

### CROSS-REFERENCES TO RELATED APPLICATIONS

The present patent application claims the priority of Japanese patent application No. 2017/153180 filed on Aug. 8, 2017, the entire contents of which are hereby incorporated by reference.

### TECHNICAL FIELD

The present invention relates to an operation detection device.

### BACKGROUND ART

A touch panel display is known which is provided with a touch pad arranged on a base, four load sensors arranged between the touch pad and the base at the four corners of the touch pad, and a microcomputer which detects a touched position based on output voltage of the load sensors (see, e.g., Patent Literature 1).

### CITATION LIST

### Patent Literature

Patent Literature 1: JP 2012/68836 A

### SUMMARY OF INVENTION

### Technical Problem

The touch panel display described in Patent Literature 1 may have a problem that it is difficult to make contact between all the four load sensors and the touch pad and, when the load sensors are adjusted in height, etc., a three-point support state with one point remaining with no contact occurs and results in abnormal noise or wobbling at the time an operation is performed.

It is an object of the invention to provide an operation detection device that can prevent abnormal noise or wobbling at the time an operation is performed.

### Solution to Problem

According to an embodiment of the invention, an operation detection device comprises: an operation unit comprising an operation surface to be operated thereon; a base portion to which the operation unit is attached; a plurality of load sensors that are arranged between the operation unit and the base portion to detect a load applied to the operation surface; and a plurality of elastic bodies that are attached to the base portion and to the operation unit to cause the plurality of load sensors to contact with the operation unit by an elastic force thereof.

### Advantageous Effects of Invention

According to an embodiment of the invention, it is possible to provide an operation detection device that can prevent abnormal noise or wobbling at the time an operation is performed.

### BRIEF DESCRIPTION OF DRAWINGS

FIG. 1 is an exploded perspective view showing a touch pad in an embodiment.

FIG. 2A is a perspective view showing the touch pad in the embodiment.

FIG. 2B is a block diagram illustrating the touch pad in the embodiment.

FIG. 3A is a schematic cross-sectional view showing an essential configuration of the touch pad in the embodiment.

FIG. 3B is a schematic cross-sectional view when a cross section taken along a line III(b)-III(b) in FIG. 2A is viewed in the direction of the arrow.

FIG. 3C is an explanatory diagram illustrating an elastic force of an elastic body in the embodiment.

### DESCRIPTION OF EMBODIMENTS

### Summary of the Embodiment

An operation detection device in the embodiment has an operation unit that comprises an operation surface to be operated, a base portion to which the operation unit is attached, plural load sensors that are arranged between the operation unit and the base portion and detect a load applied to the operation surface, and plural elastic bodies that are attached to the base portion and to the operation unit and bring the plural load sensors into contact with the operation unit by an elastic force.

In this operation detection device, the elastic bodies ensure that the operation unit comes into contact with the plural load sensors. Therefore, unlike when such a configuration is not adopted, it is possible to prevent any load sensors from remaining with no contact and thereby prevent abnormal noise or wobbling at the time an operation is performed.

### Embodiment

### (General Configuration of Touch Pad 1)

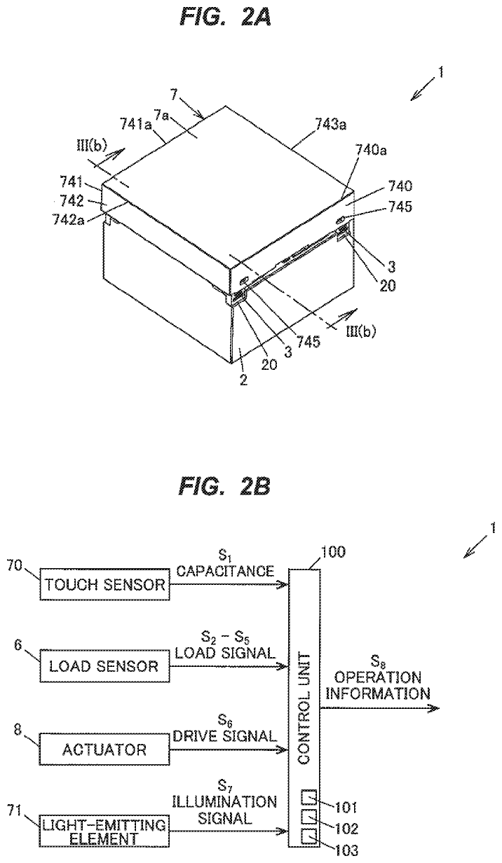

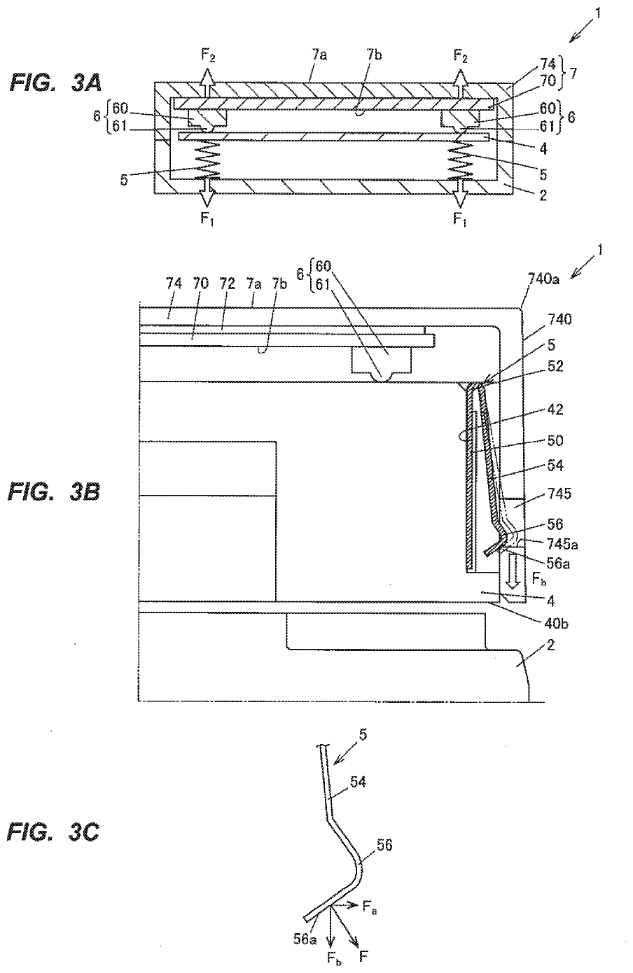

In each drawing for the present embodiment, a scale ratio may be different from the actual ratio. In addition, FIGS. 3A to 3C are schematic views in which the actual shape is simplified for the purpose of explanation. Furthermore, in FIG. 2B, flows of main signals and information are indicated by arrows.

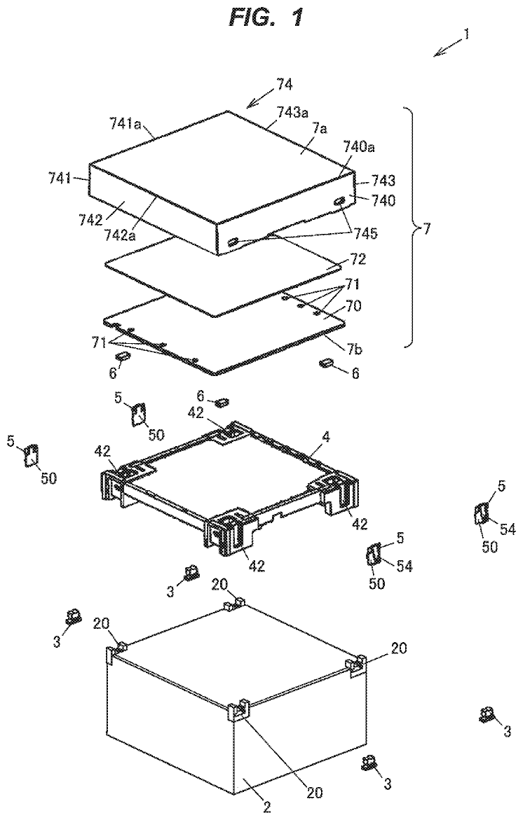

A touch pad 1 as the operation detection device is arranged on a floor console between a driver's seat and a passenger's seat in a vehicle, as an example. The touch pad 1 is arranged such that the left side on the paper plane of FIG. 1 (on the edge 742a side of an operation surface 7a) is the rear side of the vehicle and the right side (on the edge 743a side) is the front side, as an example. The touch pad 1 is configured to operate an electronic device mounted on the vehicle, as an example. The touch pad 1 is configured to detect, e.g., swipe operation, tap operation, pinch operation and push operation, etc., performed on the operation surface 7a.

The touch pad 1 has, e.g., an operation unit 7 having the operation surface 7a to be operated, a base 4 as the base portion to which the operation unit 7 is attached, plural load sensors 6 which are arranged between the operation unit 7 and the base 4 and detect a load applied to the operation surface 7a, and plural elastic bodies 5 which are attached to the base 4 and to the operation unit 7 and bring the plural load sensors 6 into contact with the operation unit 7 by an elastic force, as shown in FIGS. 1 to 2B.

The touch pad 1 is also provided with, e.g., an actuator 8 and a control unit 100 which controls a touch sensor 70, light-emitting elements 71, the load sensors 6 and the actuator 8, as shown in FIGS. 2B and 3A.

The plural load sensors 6 are arranged to match the shape of the operation surface 7a. The arrangement matching the shape of the operation surface 7a is an arrangement well-balanced and matching the shape of the operation surface 7a as an example, in more detail, an arrangement in which the center of gravity of the area surrounded by the plural load sensors 6 coincides with the center of gravity of the operation surface 7a. As an example of the arrangement well-balanced and matching the shape of the operation surface 7a, the plural load sensors 6 in the present embodiment are arranged under the four corners of the rectangular operation surface 7a, in other words, arranged on a reverse surface or back side of the operation surface 7a, as shown in FIGS. 1 and 3B. That is, the touch pad 1 is provided with four load sensors 6. The outer shape of the operation surface 7a is not limited to a rectangle and may be a circle, a triangle, a trapezoid, etc., or a shape formed by combining these shapes. In addition, the operation surface 7a may be a flat surface, a concave surface, a convex surface, etc., or a shape formed by combining these shapes.

The base 4 integrated with the operation unit 7 is attached to, e.g., a case 2, as shown in FIG. 1. The case 2 is formed of a resin material such as PBT (polybutylene terephthalate), as an example. For example, four cushioning members 3 formed of a resin material are arranged between the case 2 and a base 4, as shown in FIGS. 1 and 2A. The cushioning members 3 are attached to fitting portions 20 of the case 2.

### (Configuration of the Base 4)

As an example, the base 4 is formed of a resin material such as ABS (acrylonitrile butadiene styrene). The operation unit 7 is arranged on an upper surface 40a side of the base 4. The actuator 8 is arranged on a lower surface 40h side of the base 4.

The base 4 is provided with, e.g., insertion portions 42, two each located under a pair of edges 740a and 741a of the operation surface 7a, as shown in FIG. 1. An attachment portion 50 of the elastic body 5 can be inserted into the insertion portion 42 from above. In addition, the insertion portion 42 is provided at a position close to the installation position of the load sensor 6.

### (Configuration of the Elastic Body 5)

The plural elastic bodies 5 are arranged to match the shape of the operation surface 7a. As an example, the arrangement matching the shape of the operation surface 7a is an arrangement in which the center of gravity of the area surrounded by the plural elastic bodies 5 coincides with the center of gravity of the operation surface 7a. As an example, the plural elastic bodies 5 in the present embodiment are arranged under the pair of opposing edges 740a and 741a of the rectangular operation surface 7a. The elastic body 5 has, e.g., an attachment portion 50 attached to the base 4, a turned-back portion 54 protruding from an end of the attachment portion 50 and folded back, and a bulged portion 56 provided at an end of the turned-back portion 54 and fitted into a recessed portion 745 of the operation unit 7 (described later), as shown in FIG. 3B.

The elastic body 5 is formed of, e.g., a metal material such as stainless steel. The attachment portion 50 has, e.g., a plate shape, as shown in FIG. 1. The attachment portion 50 is, e.g., inserted into the insertion portion 42 of the base 4 and is integrated with the base 4, as shown in FIG. 1.

The turned-back portion 54 has a more elongated shape than the attachment portion 50. Since a portion protruding from an upper portion of the attachment portion 50 is bent toward the attachment portion 50 to form the turned-back portion 54, a curved portion 52 is formed between the turned-back portion 54 and the attachment portion 50.

The bulged portion 56 is formed by outwardly (toward the opposite side to the attachment portion 50) bending a portion close to an end of the turned-back portion 54. When attaching a panel 74, the bulged portion 56 is, e.g., pressed in a direction toward the base 4 from the state indicated by a phantom line in FIG. 3B and is then fitted into the recessed portion 745 in a state of being bent at the curved portion 52.

An elastic force to return to the state indicated by the phantom line is generated in the elastic body 5 due to the bend at the curved portion 52 or deformation of the turned-back portion 54 and the bulged portion 56 caused by attaching the panel 74, and an inclined surface 56a of the bulged portion 56 located at the end applies, e.g., a force F to a lower surface 745a of the recessed portion 745 in a normal direction of the inclined surface 56a, as shown in FIGS. 3B and 3C.

The force F can be resolved into, e.g., a horizontal force Fa and a vertical force Fb, as shown in FIG. 3C. The vertical force Fb is a downward force indicated by an arrow in FIG. 3B and is a force bringing the operation unit 7 into contact with the load sensor 6 as shown in FIG. 3A.

Since the elastic bodies 5 are arranged, two each, on the both sides where the pair of edges 740a and 741a of the operation unit 7 are respectively located, the operation unit 7 can be brought into contact with the load sensors 6 even though the elastic bodies 5 are not provided on the lateral portion 742 side and on the lateral portion 743 side.

As a modification, the elastic bodies 5 may be configured as, e.g., coil springs which are arranged under a pair of edges and bring the panel 74 of the operation unit 7 into contact with the four load sensors 6 by applying an elastic force to the case 2 and the panel 74 of the operation unit 7, as shown in FIG. 3A. In detail, in the touch pad 1 of the modification, the touch sensor 70, the load sensors 6, the base 4 and the elastic bodies 5 are arranged inside the case 2 and the panel 74 of the operation unit 7 which are integrated. In this case, since the elastic bodies 5 apply, e.g., an elastic force F₁ to the case 2 in the downward direction of the paper plane of FIG. 3A and also apply an elastic force F₂ to the panel 74 in the upward direction via the base 4, the load sensors 6 and the touch sensor 70, it is possible to reliably bring the panel 74 of the operation unit 7 into contact with the load sensors 6.

### (Configuration of the Load Sensor 6)

The load sensor 6 is, e.g., a piezoresistive or capacitive MEMS (Micro-Electro-Mechanical Systems). As an example, the load sensor 6 in the present embodiment is a capacitive sensor in which a bridge circuit is composed of four gauges.

The load sensor 6 has, e.g., a load button 61 which protrudes from a main body 60. The load sensor 6 is configured that a load applied to the load button 61 causes a change in the resistance values of the gauges located therein and the output of the bridge circuit changes accordingly. The load sensors 6 are arranged on a lower surface 7b of the operation unit 7. The lower surface 7b is a lower surface of a substrate of the operation unit 7, as an example.

The four load sensors 6 output, e.g., load signals S₂ to S₅ to the control unit 100, as shown in FIG. 2B. For example, the control unit 100 converts the load signals S₂ to S₅ into a load and determines whether or not a push operation is performed.

### (Configuration of the Operation Unit 7)

As an example, the operation unit 7 has the touch sensor 70, a light guide 72 and a panel 74, as shown in FIG. 1.

The touch sensor 70 is, e.g., a capacitive touch sensor and is configured to detect multi-touch. In detail, the touch sensor 70 is configured that plural drive electrodes and plural detection electrodes intersecting into a grid while maintaining insulation therebetween are provided on a substrate.

As an example, the substrate is a printed circuit board on which plural light-emitting elements 71 are arranged at opposing edges, as shown in FIG. 1. The light-emitting elements 71 emit light based on, e.g., an illumination signal S₇ output from the control unit 100.

The touch sensor 70 reads capacitance of the plural drive electrodes and the plural detection electrodes in all combinations and outputs the capacitance for one cycle as capacitance S₁ to the control unit 100.

The light guide 72 is formed of, e.g., a highly transparent resin material such as acryl and has a sheet shape. The light guide 72 is attached to the panel 74 by, e.g., an adhesive.

The light guide 72 guides light of the light-emitting elements 71 in a direction toward the operation surface 7a so that the operation surface 7a is illuminated. Thus, the light guide 72 may contain diffusing particles, etc., which diffuse light of the light-emitting elements 71.

The panel 74 is formed of, e.g., a transparent resin such as PC. In addition, for example, a transparent region transparent to light and a light-blocking region blocking light are formed on the panel 74 by printing, etc., and symbols are thereby formed on the operation surface 7a.

The panel 74 has, e.g., a box shape having the operation surface 7a on the upper side and opened on the lower side and is provided with the recessed portions 745, two each on a pair of opposing lateral portions 740 and 741, as shown in FIGS. 1 and 38.

As described above, the bulged portions 56 of the elastic bodies 5 are fitted into the recessed portions 745, resulting in that the base 4, the touch sensor 70, the light guide 72 and the panel 74 are integrated and the operation unit 7 reliably comes into contact with the four load sensors 6.

### (Configuration of the Actuator 8)

The actuator 8 is provided to cause vibration of the operation surface 7a through the base 4. As an example, the actuator 8 is a unimorph piezoelectric actuator.

The actuator 8 causes vibration based on, e.g., a drive signal S₆ output from the control unit 100, as shown in FIG. 2B.

### (Configuration of the Control Unit 100)

The control unit 100 is, e.g., a microcomputer composed of a CPU (Central Processing Unit) performing calculation and processing, etc., of the acquired data according to a stored program, a RAM (Random Access Memory) and a ROM (Read Only Memory) as semiconductor memories, etc. The ROM stores, e.g., a program for operation of the control unit 100, a capacitance threshold 101, a load threshold 102 and drive information 103. The RAM is used as, e.g., a storage area for temporarily storing calculation results, etc.

When, e.g., the operation unit 7 detects an operation and the load sensors 6 detect a load caused by the operation, the control unit 100 controls a controlled device by judging that the a push operation has been performed, and the control unit 100 also controls the actuator 8 to cause vibration of the operation surface 7a, thereby providing tactile feedback to indicate that the push operation has been received. Then, the control unit 100 generates operation information S₈ which includes the coordinate values of the operation-detected point and information about whether or not a push operation has been performed, and the control unit 100 outputs the operation information. S₈ to the controlled device.

The controlled device is, e.g., a navigation device, a music and video player, or an air conditioner, etc.

In detail, the control unit 100 periodically acquires the capacitance S₁ from the touch sensor 70 and compares the capacitance S₁ to the capacitance threshold 101. When, e.g., a capacitance of not less than the capacitance threshold 101 is present, the control unit 100 calculates the operation-detected point on the operation surface 7a based on distribution of the capacitance. As an example, weighted average, etc., is used for the calculation.

The control unit 100 also compares a load obtained based on the load signals S₂ to S₅ from the load sensors 6, to the load threshold 102. When a load of not less than the load threshold 102 is detected, the control unit 100 determines that a push operation has been performed.

The drive information 103 is, e.g., information about the drive pattern of the drive signal S₆. When a push operation is detected, the control unit 100 generates the drive signal S₆ which has a drive pattern indicating that the push operation has been received, and the control unit 100 outputs the drive signal S₆ to the actuator 8 to provide tactile feedback. As a modification, the tactile feedback may be, e.g., tactile feedback mimicking a sensation of pushing a mechanical push button, etc.

Also as a modification, to detect swipe operation or touch operation, the control unit 100 may be configured to determine an operation by detection of a capacitance of not less than the capacitance threshold 101 in combination with detection of a load of not less than a predetermined load. Since the control unit 100 makes the determination based on such a combination, it is possible to prevent a false detection caused by an operating finger which is distant from the operation surface 7a, i.e., moving nearby in the air. In addition, since the control unit 100 makes the determination based on the combination described above, it is possible to prevent a false detection based on a load which is detected when the operating finger unintentionally touches due to vibration of a vehicle.

The operation of the touch pad 1 will be described below.

### (Operation)

The control unit 100 of the touch pad 1 outputs the illumination signal S₇ to the light-emitting elements 71 and illuminates the operation surface 7a when, e.g., the power of the vehicle is turned on. Then, the control unit 100 acquires and monitors the capacitance S₁ and the load signals S₂ to S₅ while comparing with the capacitance threshold 101 and the load threshold 102.

When an operation is detected but a push operation is not detected, the control unit 100 generates the operation information S₈ including the coordinate values of the operation-detected point and the fact of no push operation performed, and outputs the operation information S₈ to the controlled device. Meanwhile, when a push operation is detected, the control unit 100 generates the operation information S₈ including the coordinate values of the operation-detected point and the fact of push operation performed, and outputs the operation information S₈ to the controlled device.

### Effects of the Embodiment

The touch pad 1 of the present embodiment can prevent abnormal noise or wobbling at the time an operation is performed. In detail, in the touch pad 1, the elastic bodies 5 ensure that the operation unit 7 comes into contact with the four load sensors 6. Therefore, unlike when such a configuration is not adopted, it is possible to prevent any load sensors 6 from remaining with no contact and thereby prevent abnormal noise or wobbling at the time an operation is performed.

In the touch pad 1, the operation unit 7 reliably comes into contact with the four load sensors 6. Therefore, unlike when any of the load sensors is not in contact with the operation unit 7, wobbling is prevented and it is thus possible to prevent abnormal noise no matter where on the operation surface 7a a tap operation or a double-tapping operation is performed. In addition, since the operation unit 7 reliably comes into contact with the four load sensors 6, the touch pad 1 has a high load detection accuracy and can accurately detect an operation performed at any position on the operation surface 7a.

Since height adjustment, etc., of the load sensors 6 for reliable contact between the four load sensors 6 and the operation unit 7 is not required, the touch pad 1 can be manufactured at a lower cost than when adjustment is required.

Since the elastic body 5 is thin and can be arranged in a narrow space between the base 4 and the lateral portions 740 and 741 of the panel 74, the size of the touch pad 1 can be reduced as compared to when such a configuration is not adopted. In addition, since the elastic bodies 5 are arranged close to the installation positions of the load sensors 6 in the touch pad 1, the operation unit 7 can be brought into contact with the load sensors 6 more reliably than when such a configuration is not adopted.

Since the base 4 and the panel 74, etc., are integrated via the elastic bodies 5 only by attaching the elastic bodies 5 to the base 4 and then fitting the panel 74 having the light guide 72 as well as the touch sensor 70 to the base 4, the touch pad 1 can be assembled more easily than when such a configuration is not adopted.

In the touch pad 1, the operation unit 7 reliably comes into contact with the load sensors 6. Therefore, unlike when such a configuration is not adopted, the load sensors 6 can be arranged to be well-balanced and to match the shape of the operation surface 7a.

As a modification, the touch pad 1 may have a configuration in which the touch sensor 70 is not provided. The touch pad 1 in this case can accurately detect the operated position based on an output of each load sensor 6 since the operation unit 7 is reliably in contact with the four load sensors 6.

Although some embodiments and modifications of the invention have been described above, the embodiments and modifications are merely an example and the invention according to claims is not to be limited thereto. These new embodiments and modifications may be implemented in various other forms, and various omissions, substitutions and changes, etc., can be made without departing from the gist of the invention. In addition, all combinations of the features described in these embodiments and modifications are not necessary to solve the problem of the invention. Further, these embodiments and modifications are included within the scope and gist of the invention and also within the invention described in the claims and the equivalency thereof.

### REFERENCE SIGNS LIST

1 TOUCH PAD
2 CASE
4 BASE
5 ELASTIC BODY
6 LOAD SENSOR
7 OPERATION UNIT
7a OPERATION SURFACE
7b LOWER SURFACE
20 FITTING PORTION
50 ATTACHMENT PORTION
54 TURNED-BACK PORTION
56 BULGED PORTION
60 MAIN BODY
61 LOAD BUTTON
100 CONTROL UNIT
740a-743a EDGE
745 RECESSED PORTION

1. An operation detection device, comprising:
an operation unit comprising an operation surface to be operated thereon;
a base portion to which the operation unit is attached;
a plurality of load sensors that are arranged between the operation unit and the base portion to detect a load applied to the operation surface; and
a plurality of elastic bodies that are attached to the base portion and to the operation unit to cause the plurality of load sensors to contact with the operation unit by an elastic force thereof.

2. The operation detection device according to claim 1, wherein the plurality of elastic bodies are arranged respectively close to the installation positions of the plurality of load sensors.

3. The operation detection device according to claim 1, wherein the plurality of load sensors are arranged to match the shape of the operation surface.

4. The operation detection device according to claim 3, wherein the operation surface has a rectangular shape, and the plurality of load sensors are arranged under the four corners of the operation surface.

5. The operation detection device according to claim 1, wherein the plurality of elastic bodies are arranged to match the shape of the operation surface.

6. The operation detection device according to claim 5, wherein the plurality of elastic bodies are arranged under a pair of opposing edges of the operation surface.

7. The operation detection device according to claim 1, wherein the operation unit has a box shape having the operation surface on the upper side and opened on the lower side and comprises recessed portions on a pair of opposing lateral portions, and the elastic body comprises an attachment portion attached to the base portion, a turned-back portion protruding from an end of the attachment portion and folded back, and a bulged portion provided at an end of the turned-back portion and fitted into the recessed portion of the operation unit.

8. The operation detection device according to claim 1, wherein the load sensor comprises a main body internally comprising a bridge circuit formed of gauges and a load button protruding from the main body, and is configured that the resistance values of the gauges change according to a load applied to the load button and an output of the bridge circuit thereby changes.

9. The operation detection device according claim 1, comprising:
a control unit that is configured to compare a load threshold to a load based on load signals from the load sensors and, when a load greater than the load threshold is detected, to output operation information to a controlled device by judging that a push operation has been performed on the operation unit.

10. An operation detection device, comprising:
an operation unit comprising an operation surface to be operated thereon;
a plurality of load sensors that are arranged under the operation unit to detect a load applied to the operation surface;
a base portion arranged under the load sensors;
a case that is integrated with the operation unit and houses the load sensors and the base portion in a housing space formed between itself and the operation unit; and
a plurality of elastic bodies that generate an elastic force between the case and the base portion.
